(19) United States
(12) Patent Application Publication
(10) Pub. No.: US 2004/0062928 A1
(43) Pub. Date: Apr. 1, 2004

(54) Method for producing a sintered, supported polycrystalline diamond compact

(75) Inventors: Ram Raghavan, Westerville, OH (US); James Michael McHale JR., Worthington, OH (US); Robert Dean Scurlock, Johnstown, OH (US)

Correspondence Address: Hanh T. Pham, GE Plastics, One Plastics Avenue, Pittsfield, MA, 01201, US

(73) Assignee: General Electric Company

(21) Appl. No.: 10/621,710

(22) Filed: Jul. 17, 2003

Related U.S. Application Data
(60) Provisional application No. 60/414,987, filed on Oct. 1, 2002.

(51) Int. Cl. B32B 9/00

(52) U.S. Cl. 428/408

(57) ABSTRACT

A sintered supported polycrystalline diamond compact (PCD) having improved abrasion resistance properties is manufactured by subjecting diamond crystals placed in adjacency with a metal carbide support containing a catalyst/sintering aid to high pressure/high temperature (HP/HT) processing. Said PCD compact comprises: a) a body of diamond crystals comprising a mixture of about 60 wt % to about 80 wt. % of coarse fraction having an average particle size ranging from about 30 to 60 μm and a fine fraction being about not substantially greater than about 20% of the average particle size of said coarse fraction; and b) a support body comprising about 12 wt. % or less of a catalyst/sintering.

### CROSS-REFERENCE TO RELATED APPLICATIONS

This application claims priority on U.S. Provisional Application Serial No. 60/414,987, filed on Oct. 1, 2002.

### BACKGROUND OF THE INVENTION

The present invention relates generally to abrasive particle compacts and more particularly to such compacts having improved properties including, inter alia, abrasion resistance, e.g., to machining nonferrous metals, ceramics, and wood-based composites.

A compact may be characterized generally as an integrally-bonded structure formed of a sintered, polycrystalline mass of abrasive particles, such as diamond or cubic boron nitride (CBN). Although such compacts may be self-bonded without the aid of a bonding matrix or second phase, it generally is preferred, as is discussed in U.S. Pat. Nos. 4,063,909 and 4,601,423, to employ a suitable bonding matrix which usually is a metal such as cobalt, iron, nickel, platinum, titanium, chromium, tantalum, copper, or an alloy or mixture thereof. The bonding matrix, which is provided at from about 5% to 35% by volume, additionally may contain recrystallization or growth catalyst such as aluminum for CBN or cobalt for diamond.

For many applications, it is preferred that the compact is supported by its bonding to substrate material to form a laminate or supported compact arrangement. Typically, the substrate material is provided as a cemented metal carbide which comprises, e.g., tungsten, titanium, or tantalum carbide particles, or a mixture thereof, which are bonded together with a binder of between about 6% to about 25% by weight of a metal such as cobalt, nickel, or iron, or a mixture or alloy thereof. U.S. Pat. Nos. 3,831,428; 3,852,078; and 3,876,751 have shown that compacts and supported compacts have found acceptance in a variety of applications as parts or blanks for cutting and dressing tools, as drill bits, and as wear parts or surfaces.

The basic high pressure/high temperature (HP/HT) method for manufacturing the polycrystalline compacts and supported compacts of the type herein involved entails the placing of an unsintered mass of abrasive, crystalline particles, such as diamond or CBN, or a mixture thereof, within a protectively shielded enclosure which is disposed within the reaction cell of an HP/HT apparatus as disclosed in U.S. Pat. No. 4,954,139. Additionally placed in the enclosure with the abrasive particles may be a metal catalyst if the sintering of diamond particles is contemplated, as well as a pre-formed mass of cemented metal carbide for supporting the abrasive particles and to thereby form a supported compact therewith. The contents of the cell then are subjected to processing conditions selected as sufficient to effect intercrystalline bonding between adjacent grains of abrasive particles and, optionally, the joining of sintered particles to the cemented metal carbide support. Such processing conditions generally involve the imposition for about 3 to 120 minutes of a temperature of at least 1000° C. and a pressure of at least 20 Kbar.

Regarding the sintering of polycrystalline diamond (PCD) compacts or supported compacts, the catalyst metal may be provided in a pre-consolidated form disposed adjacent the crystal particles. For example, the metal catalyst may be configured as an annulus into which is received a cylinder of abrasive crystal particles, or as a disc which is disposed above or below the crystalline mass. Alternatively, the metal catalyst, or solvent as it is also known, may be provided in a powdered form and intermixed with the abrasive crystalline particles, or as a cemented metal carbide or carbide molding powder which may be cold pressed into shape and wherein the cementing agent is provided as a catalyst or solvent for diamond recrystallization or growth. Typically, the metal catalyst is selected from cobalt, iron, or nickel, or an alloy or mixture thereof, but other metals such as ruthenium, rhodium, palladium, chromium, manganese, tantalum, copper, and alloys and mixtures thereof also may be employed.

Under the specified HT/HP conditions, the metal catalyst, in whatever form provided, is caused to penetrate or “sweep” into the abrasive layer by means of either diffusion or capillary action, and is thereby made available as a catalyst or solvent for recrystallization or crystal intergrowth. The HT/HP conditions, which operate in the diamond stable thermodynamic region above the equilibrium between diamond and graphite phases, effect a compaction of the abrasive crystal particles which is characterized by intercrystalline diamond-to-diamond bonding wherein parts of each crystalline lattice are shared between adjacent crystal grains. Preferably, the diamond concentration in the compact or in the abrasive table of the supported compact is at least about 70% by volume. Methods for making diamond compacts and supported compacts are known in the art (See U.S. Pat. No. 4,954,139).

U.S. Pat. No. 5,855,996 and U.S. Pat. No. 5,468,268 describe the effect of particle size distribution (PSD) of the polycrystalline diamond compact (PCD) on the performance characteristics of the PCD compact.

Applicants have surprisingly found a method to improve abrasion resistance properties in PCD compacts by varying the composition of the diamond micron powder and supporting substrate.

### BRIEF SUMMARY OF THE INVENTION

A sintered supported polycrystalline diamond compact (PCD) having improved abrasion resistance properties, which includes: a) diamond crystals comprising a mixture of a coarse fraction having an average particle size ranging from about 20 to 70 μm and a fine fraction being about not substantially greater than about 20% of the average particle size of said coarse fraction, wherein the weight of the coarse diamond fraction in the mixture ranges from greater than 60 wt % to about 90 wt %; and b) a carbide substrate having about or less than 20 vol % catalyst/sintering aid.

The invention further relates a process to improve abrasion resistance properties of PCD compacts, the process comprising the step of subjecting diamond crystals placed in adjacency with a metal carbide support containing a binder which acts as a catalyst/sintering aid to high pressure/high temperature (HP/HT) processing.

### DETAILED DESCRIPTION OF THE INVENTION

The invention relates to a sintered supported PCD compact with improved abrasion resistance to machining, for example, non-ferrous metals, ceramics, and wood-based composites. Each compact is generally cylindrical and of circular cross-section, comprising a front facing table or disc of polycrystalline diamond (“PCD”) bonded to a cylindrical substrate of cemented tungsten carbide.

Applicants have found two variables that surprisingly and positively influence abrasion resistance properties. The first variable is the diamond micron powder feed, e.g., with a dual mode distribution in the feed (“bimodal feed”). The second variable is in the amount of binder/catalyst/sintering aid.

Bimodal-Feed for the Diamond Disc. The diamond crystals used in the present process can be natural or synthetic, with the feed to the process being bimodal, i.e., comprising a mixture of a coarse fraction and a fine fraction. The coarse fraction has an average particle size ranging from about 15 to 70 μm. By “average particle size” is meant that the individual particles have a range of sizes with the mean particle size representing the “average”. The fine fraction is less than about ½ the size of the coarse fraction, i.e., ranging in average particle size from about 1 to 35 μm. In a second embodiment, the fine fraction has an average particle size ranging from about 3 to 25 μm.

In one embodiment, the weight ratio of the coarse diamond fraction to the fine diamond fraction ranges from about greater than 60% to about 90% coarse diamond with the balance being the fine diamond fraction. Generally, the weight ratio of the coarse fraction to the fine fraction will range from about 70:30 to about 80:20. In a second embodiment, the weight ratio of the coarse fraction to the fine fraction ranges from about 60:40 to about 80:20.

Sizing of diamond crystals into fine fraction, coarse fraction; or other sizes in between, is via processes known in the art, i.e., jet-milling of larger diamond crystals, and the like.

In one embodiment, optional materials of up to 20 wt. % of the total weight of the diamond crystal may be incorporated in the composition of the disc. Examples of optional materials include carbonates as a sintering binder-catatalyst, e.g., a powdery carbonate of Mg, Ca, Sr, or Ba, or combinations thereof. In another embodiment, the binder catalyst may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix.

Carbide Substrate: The cemented metal carbide substrate or support is conventional in composition and, thus, may be include any of the Group IVB, VB, or VIB metals, which are pressed and sintered in the presence of a binder of cobalt, nickel or iron, or alloys thereof. In one embodiment, the metal carbide is tungsten carbide. In one embodiment of the invention, the binder/catalyst/sintering aid is Co.

The amount of catalyst/sintering aid in the support material of the invention is kept lower than that typically encountered in the commercial field, i.e., of about 22 vol % (14 wt. % for Co bonded WC). In one embodiment of the invention, the catalyst/sintering aid is in the range of about 10 to 22 vol %. In a second embodiment, the amount is about 10 to 15 vol % In a third embodiment, the amount is less than 20 vol %. In a fourth embodiment, the amount is about or less than 16 vol %.

As the data demonstrates, improved abrasion resistance is seen with lower binder/catalyst/sintering aid contents even with a unimodal grain size of PCD. The greatest abrasion resistances, however, are seen with a combination of lower binder/catalyst/sintering aid contents and the bimodal PCD mixtures disclosed herein. It is known that the catalyst/sintering aid sweeps out from the support and through the PCD mixture in the press to aid formation of a polycrystalline diamond layer. The lower residual catalyst/sintering aid content in the carbide, support layer of the present invention surprisingly produces a stiffer support that contributes beneficially to improving abrasion resistance of the sintered PCD compact product.

HP/HT Process: In the first embodiment of the invention, both the bodies of diamond and carbide material plus sintering aid/binder/catalyst are applied as powders and sintered simultaneously in a single press operation (HP/HT process). As described in the background section above, the mixture of diamond crystals and mass of carbide are placed in a HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one embodiment, the processing conditions generally involve the imposition for about 3 to 120 minutes of a temperature of at least 1000° C. and a pressure of at least 20 Kbar.

In yet another embodiment of the invention, both the disc and the substrate are pre-sintered in separate processes before being bonded together in the HP/HT press or by brazing.

In this embodiment, a PCD disc is preformed by mixing the bimodal feed diamond with optional carbonate binder-catalyst also in powdered form, and the mixture is packed into an appropriately shaped can and is then subjected to extremely high pressure and temperature in a press. Typically, the pressure is at least 20 Kbar and the temperature of at least 1000° C., e.g., 2000° C.

The preformed disc is then placed in the appropriate position on the upper surface of the preform carbide substrate (incorporating a binder catalyst), and the assembly is located in a suitably shaped can. The assembly is then subjected to high temperature and pressure in a press, the order of temperature and pressure being that which is normally used in the manufacture of conventional PCD. During this process the binder catalyst migrates from the substrate into the diamond powder and acts as a binder-catalyst to effect diamond-to-diamond bonding in the layer and also serves to bond the diamond layer to the substrate. The sintering process also serves to bond the disc to the substrate.

In the commercial production of supported compacts in general, it is common for the product or blank which is recovered from the reaction cell of the HP/HT apparatus to be subjected to a variety of finishing operations which include cutting, such as by electrode discharge machining or with lasers, milling, and especially grinding to remove any adherent shield metal from the outer surfaces of the compact. Such operations additionally are employed to machine the compact into a cylindrical shape or the like which meets product specifications as to diamond abrasive table thickness and/or carbide support thickness.

### EXAMPLES

Examples are provided herein to illustrate the invention but are not intended to limit the scope of the invention.

### Example 1

The first step in making the compact is to prepare the appropriate diamond micron powder blend. This is accomplished by mixing diamond powders of two distinct particle size distributions (for example, 80% by weight of ˜25 micron diamond powder and 20% by weight of ˜5 micron diamond powder) in a turbula blender. The blended powder is poured into a tantalum (Ta) cup and covered with a cemented WC disk Several of these cups are loaded into a high temperature/high pressure reaction cell and subjected to pressures of about 5000 psi at temperatures between 1300° and 1500° C. for about 30 minutes to form the sintered PCD compact. The PCD compacts are recovered from the reaction cell and finished such that the diamond layer is between 0.4-0.6 mm thick and the overall thickness of the blank is 1.6 mm. Several variations of this process using differing diamond size distributions and substrate compositions were prepared. These compositions are summarized in Table 1.

In order to test the abrasion resistance of the finished PCD compacts, the diamond layers are polished and a tool suitable for turning A390 Aluminum is fabricated from the sintered compacts. The turning speed is 1500 surface feet per minute with a feed rate of 0.005 inches per revolution and a depth of cut of 0.02 inches. The wear resistance during the machining process is monitored. The results are as follows:

TABLE 1

| | | |
|---|---|---|
| Diamond | | |
| Composition (wt %) | Co in WC | Comparative |

| 25 Micron | 5 Micron | (vol %) | Wear* |
|---|---|---|---|
| 70 | 30 | 13.2 | 0.902 |
| 80 | 20 | 13.2 | 0.778 |
| 100 | 0 | 13.2 | 0.930 |
| 70 | 30 | 22.2 | 0.990 |
| 80 | 20 | 22.2 | 0.989 |
| 100 | 0 | 22.2 | 1.000 |

Wear is comparative to unimodal 25 μ/22.2 vol % Co PCD. Lower indicative of less PCD wear.

As illustrated above, reducing the Co content in the WC substrate produces sintered PCD's with better wear resistance. However, the particle size distribution of the diamond in the feed also is an important factor in improving wear resistance. In the examples, it is helpful to control both the particle size distribution of the diamond powder feed, as well as the Co content in the WC substrate for optimum wear resistance.

### Example 2

In this example, the abrasion resistance of the PCD is tested. Tools prepared using the technique described in Example 1 are used to turn Duralcan (20% SiC in Al). The turning speed is 1500 surface feet per minute with a feed rate of 0.005 inches per revolution and a depth of cut of 0.02 inches. The machining wear of several tools is averaged and tabulated below:

TABLE 2

| Grade of PCD | Comparative wear |
|---|---|
| This Invention | 0.63 |
| Existing GE Grade | 1.00 |
| Similar Competitive Grade | 0.98 |

Duralcan is more abrasive than A390 and the above results indicate that the present invention is a substantial improvement on existing products for severe machining applications.

While the invention has been described with reference to a preferred embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims.

In this application, all units are in the metric system and all amounts and percentages are by weight, unless otherwise expressly indicated. Also, all citations referred herein are expressly incorporated herein by reference.

We claim:

1. A method for making a metal carbide supported polycrystalline diamond (PCD) compact having improved abrasion resistance properties, said method comprises the steps of:
a) providing a cell assembly comprising:
a body of diamond crystals comprising a mixture of about 60 wt % to about 90 wt. % of a coarse fraction having an average particle size ranging from about 15 to 70 μm and a fine fraction having an average particle size of less than about one half of the average particle size of the coarse fraction; and
a support body disposed adjacent said body of diamond crystals, said support body comprising a mixture of a carbide of Group WB, VB, or VIB metal and at least a sintering binder-catalyst in an amount of about or less than 20 vol % of the total weight of the support body; and
b) subjecting said cell assembly reaction to high pressure high temperature (HP/HT) conditions for a sufficient amount of time and at a sufficiently high temperature and high pressure to sinter said body of diamond crystals into a PCD layer and to bond said PCD layer to said carbide body.

2. The method of claim 1, wherein the weight ratio of the coarse fraction to the fine fraction of said body of diamond crystals ranges from about 90:10 to 60:40.

3. The method of claim 1, wherein the fine fraction of diamond crystals. ranges in size from about 1 to 25μ.

4. The method of claim 1, wherein the cemented metal carbide support comprises a carbide of Group IVB, VB, or VIB metal, and the binder is one or more of cobalt, nickel, iron, or alloys thereof.

5. The method of claim 5, wherein the cemented metal carbide support is WC and the binder is Co.

6. The method of claim 1, wherein the support body comprises at least a sintering binder-catalyst in an amount of about or less than 17 vol % of the total weight of the support body.

7. The method of claim 1, wherein HP/HT processing conditions comprising sintering of said body of diamond crystals for about 3 to 120 minutes at a temperature of at least 1000° C. and a pressure of at least 20 Kbar.

8. A sintered supported polycrystalline diamond (PCD) compact having improved abrasion resistance properties, said compact comprising:
(a) a body of diamond crystals comprising a mixture of about 60 wt % to about 90 wt. % of a coarse fraction having an average particle size ranging from about 15 to 70 μm and a fine fraction having an average particle size of less than about one half of the average particle size of the coarse fraction; and
(b) a support body in contact with the body of diamond crystals, the support body comprises a mixture of a carbide of Group IVB, VB, or VIB metal and at least a sintering binder-catalyst in an amount of about or less than 20 vol % of the total weight of the support body.

9. The PCD compact of claim 8, wherein the weight ratio of the coarse fraction to the fine fraction of diamond crystals ranges from about 90:10 to 60:40.

10. The PCD compact of claim 8, wherein the fine fraction of diamond crystals ranges in size from about 1 to 25 μm.

11. The PCD compact of claim 8, wherein the cemented metal carbide support comprises a carbide of Group IVB, VB, or VIB metal, and the binder is one or more of cobalt, nickel, iron, or alloys thereof.

12. The PCD compact of claim 11, wherein the cemented metal carbide support is WC and the binder is Co.

13. The PCD compact of claim 8, wherein said support body comprises at least a sintering binder-catalyst in an amount of about or less than 17 vol % of the total weight of the support body.

14. The. PCD compact of claim 8, wherein said compact is formed via a high pressure/high temperature (HP/HT) processing method, wherein the HP/HT processing method comprises sintering said body of diamond crystals and said support body for a sufficient period of time at a temperature of at least 1000° C. and a pressure of at least 20 Kbar.

15. The PCD compact of claim 8, wherein said compact is formed via a high pressure/high temperature (HP/HT) processing method, and wherein said body of diamond crystals and said support body are pre-formed in an HP/HT processing environment for a sufficient period of time at a temperature of at least 1000° C. and a pressure of at least 20 Kbar, prior to being fused together via brazing or in an HP/HT processing environement.
